(19) United States
(12) Patent Application Publication
(10) Pub. No.: US 2023/0135414 A1
(43) Pub. Date: May 4, 2023

(54) ENGINE CONTROLLER AND ENGINE CONTROLLING METHOD

(71) Applicant: TOYOTA JIDOSHA KABUSHIKI KAISHA, Aichi-ken (JP)

(72) Inventor: Hiroaki MIZOGUCHI, Nagoya-shi (JP)

(21) Appl. No.: 17/970,570

(22) Filed: Oct. 21, 2022

(30) Foreign Application Priority Data
Oct. 29, 2021 (JP) 2021-177609

(51) Int. Cl. F02B 39/00; F02B 37/12

(52) U.S. Cl. CPC F02B 39/005; F02B 37/12

(57) ABSTRACT

An engine controller is configured to control an engine that is mounted on a vehicle and includes a turbocharger and an electric pump. The electric pump supplies a cooling water to the turbocharger. The engine controller includes a processing device and a storage. The processing device is configured to execute a determination process that determines whether the cooling water needs to be supplied to the turbocharger after the engine is stopped, a post-stoppage pump driving process that drives the electric pump after the engine is stopped if the determination process determines that the cooling water needs to be supplied, and a recording process that records, in the storage, a number of times of execution of the post-stoppage pump driving process.

### BACKGROUND

### 1. Field

The present disclosure relates to an engine controller and an engine controlling method that control an engine mounted on a vehicle. Particularly, the present disclosure relates to an engine controller and an engine controlling method for an engine equipped with a liquid-cooled turbocharger that performs cooling with cooling water supplied by an electric pump.

### 2. Description of Related Art

If an engine is stopped immediately after a high-load operation, the turbocharger may be overheated after the engine is stopped. In order to prevent overheating of the turbocharger after the engine is stopped, an electric pump is driven to supply cooling water to the turbocharger after the engine is stopped in some cases, as described in Japanese Laid-Open Patent Publication No. 2016-079935.

If the electric pump is driven after the engine is stopped, the amount of charge of the battery decreases. This may lead to battery exhaustion. Aside from driving of the electric pump during stoppage of the engine, there are multiple possible causes of battery exhaustion. It is thus difficult to identify the causes of battery exhaustion.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an engine controller is configured to control an engine. The engine is mounted on a vehicle and includes a turbocharger and an electric pump that supplies a cooling water to the turbocharger. The engine controller includes a processor and a storage. The processor is configured to execute: a determination process that determines whether the cooling water needs to be supplied to the turbocharger after the engine is stopped; a post-stoppage pump driving process that drives the electric pump after the engine is stopped if the determination process determines that the cooling water needs to be supplied; and a recording process that records, in the storage, a number of times of execution of the post-stoppage pump driving process.

The above-described engine controller records, in the storage, a number of times of execution of the post-stoppage pump driving process, which is one of the causes of battery exhaustion. Referring to the recorded number of times of execution facilitates the determination of whether the cause of battery exhaustion is the post-stoppage pump driving process or other. This allows the cause of the battery exhaustion to be identified easily.

In the above-described engine controller, the post-stoppage pump driving process may include varying of driving time of the electric pump after stoppage of the engine depending on a temperature state of the turbocharger at the stoppage of the engine. The recording process may include recording of information of the driving time together with the number of times of execution. The processor may be configured to divide a set range of the driving time into time sections, and record the number of times of execution of the post-stoppage pump driving process for each of the time sections.

In the above-described engine controller, the vehicle may perform automatic stopping and automatic restarting of the engine in accordance with a traveling condition of the vehicle. The recording process does not record the number of times of execution of the post-stoppage pump driving process if the post-stoppage pump driving process is executed in response to the automatic stopping.

In the above-described engine controller, if the post-stoppage pump driving process is executed repeatedly due to repeated stopping and restarting of the engine, the recording process may record, as one time, the number of times of execution of the post-stoppage pump driving process.

In another general aspect, an engine controlling method configured to control an engine is provided. The engine is mounted on a vehicle and includes a turbocharger and an electric pump that supplies a cooling water to the turbocharger. The engine controlling method includes: determining whether the cooling water needs to be supplied to the turbocharger after the engine is stopped; executing a post-stoppage pump driving process that drives the electric pump after the engine is stopped if it is determined that the cooling water needs to be supplied; and recording, in a storage, a number of times of execution of the post-stoppage pump driving process.

Other features and aspects will be apparent from the following detailed description, the drawings, and the claims.

### BRIEF DESCRIPTION OF THE DRAWINGS

FIG. 1 is a schematic diagram showing an engine controller according to one embodiment.

FIG. 2 is a flowchart of a stopped state process executed by the engine controller.

FIG. 3 is a flowchart of a post-stoppage process executed by the engine controller.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

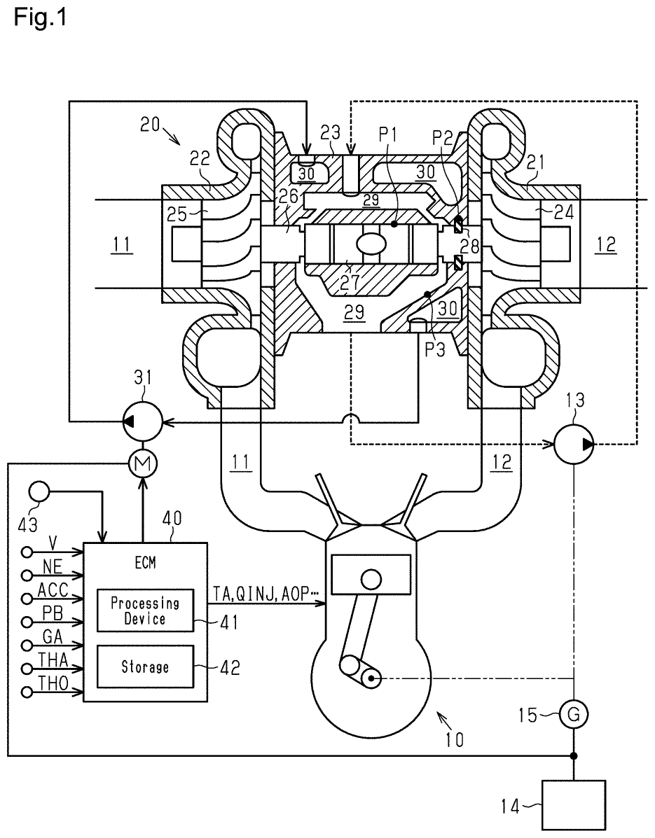

An engine controller according to one embodiment will be described with reference to FIGS. 1 to 3. The engine controller according to the present embodiment is employed in an engine 10 mounted on a vehicle.

<Configuration of Engine Controller>

First, the configuration of the engine controller according to the present embodiment will be described with reference to FIG. 1. As shown in FIG. 1, the engine 10 is provided with an intake passage 11 and an exhaust passage 12. The engine 10 is also provided with an oil pump 13, which is driven by rotation of the engine 10.

The engine 10 is provided with a turbocharger 20. The turbocharger 20 includes a turbine housing 21, which is provided on the exhaust passage 12 of the engine 10, and a compressor housing 22, which is provided on the intake passage 11 of the engine 10. The turbine housing 21 and the compressor housing 22 are coupled to each other by a journal housing 23. The turbine housing 21 incorporates a turbine wheel 24, which is rotated by receiving flow of exhaust gas flowing through the exhaust passage 12. The compressor housing 22 incorporates a compressor wheel 25, which rotates to compress intake air flowing through the intake passage 11. The journal housing 23 receives a turbine shaft 26, which couples the turbine wheel 24 and the compressor wheel 25 to each other. The turbine shaft 26 is supported by a floating bearing 27 so as to be rotatable with respect to the journal housing 23. A seal ring 28 is attached to a section of the turbine shaft 26 that is close to the section coupled to the turbine wheel 24 to restrict inflow of exhaust gas from the turbine housing 21 into the journal housing 23.

An oil passage 29 is formed in the journal housing 23 to cause oil to flow through the floating bearing 27. The oil passage 29 is supplied with some of the oil discharged by the oil pump 13. Also, a water jacket 30 is formed in the journal housing 23. The water jacket 30 is a passage through which cooling water flows. The water jacket 30 is supplied with cooling water by an electric pump 31, which is located outside the turbocharger 20. The electric pump 31 is driven by power supplied by a battery 14 mounted on the vehicle. The vehicle is also equipped with an alternator 15, which generates power when rotated by the engine 10. The battery 14 is charged with the power generated by the alternator 15.

The vehicle in which the engine 10 is mounted is equipped with an engine control module (ECM) 40. The ECM 40 includes a processing device 41, which executes various types of processes to control the engine, and a storage 42, which stores programs and data for controlling the engine. The ECM 40 receives detection signals of state quantities indicating the traveling state of the vehicle, such as a vehicle speed V, an engine rotation speed NE, an accelerator pedal depression amount ACC, a boost pressure PB, an intake air flow rate GA, an intake air temperature THA, and an outside air temperature THO. The ECM 40 also receives an IG signal, which indicates an operating state of an ignition switch 43. Based on the received signals, the ECM 40 controls, for example, a throttle opening degree TA, a fuel injection amount QINJ, and an ignition timing AOP of the engine 10.

During the operation of the engine 10, the ECM 40 estimates a housing temperature TH1, which is the temperature of the turbine housing 21, and temperatures of generation sites P1 to P3 of oil coke. The generation site P1 is a section in the oil passage 29 that is close to the seal ring 28. The occurrence site P2 is a section in the oil passage 29 that is close to the floating bearing 27. The generation site P3 is an oil drain portion, which is a section of the oil passage 29 that is on the downstream side of the floating bearing 27. In the following description, the temperature of the generation site P1 will be referred to as a seal ring temperature TH2, the temperature of the generation site P2 will be referred to as a bearing temperature TH3, and the temperature of the generation site P3 will be referred to as an oil drain temperature TH4.

The ECM 40 estimates the housing temperature TH1, the seal ring temperature TH2, the bearing temperature TH3, and the oil drain temperature TH4 based on various state quantities that represent the traveling condition of the vehicle. The state quantities used to estimate the temperatures include the vehicle speed V, the engine rotation speed NE, the accelerator pedal depression amount ACC, the fuel injection amount QINJ, the boost pressure PB, the intake air flow rate GA, the intake air temperature THA, and the outside air temperature THO. The temperatures are estimated, for example, by a neural network that has been trained through machine learning.

The vehicle on which the engine 10 is mounted performs automatic stopping and automatic restarting of the engine 10 in accordance with the traveling condition of the vehicle. The automatic stopping and the automatic restarting of the engine 10 are performed only when the amount of charge of the battery 14 is greater than or equal to a certain level. In the following description, the stopping of the engine 10 that is not the automatic stopping but is performed by turning off the ignition switch 43 will be referred to as manual stopping of the engine 10.

<Post-Stoppage Pump Driving Process>

When the engine 10 is stopped, the ECM 40 determines whether the turbocharger 20 needs to be cooled based on the housing temperature TH1, the seal ring temperature TH2, the bearing temperature TH3, and the oil drain temperature TH4. When determining that such cooling is needed, the ECM 40 executes a post-stoppage pump driving process, which drives the electric pump 31 after the engine 10 is stopped, thereby supplying cooling water to cool the turbocharger 20.

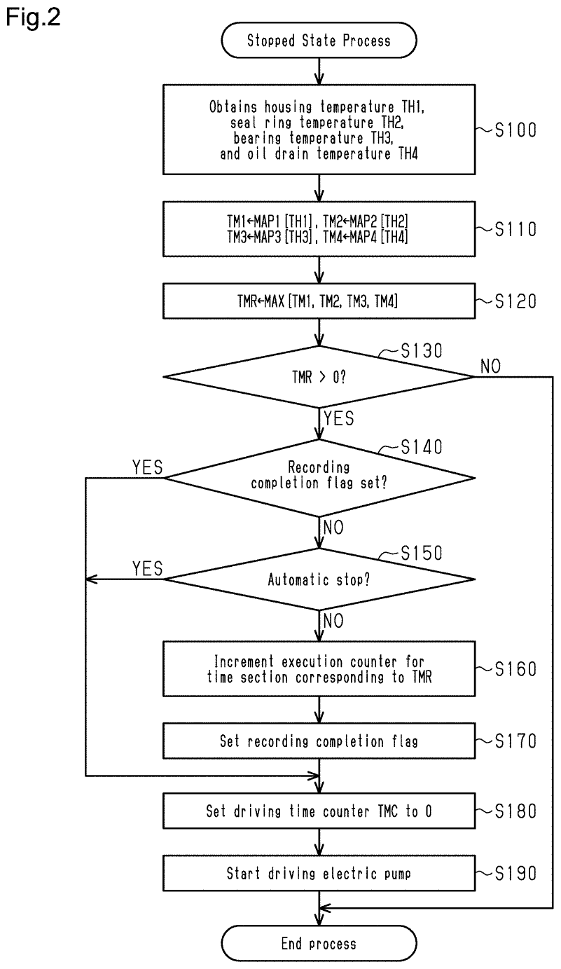

FIG. 2 shows the flowchart of a stopped state process. When the engine 10 is stopped, the ECM 40 executes the stopped state process in order to execute the post-stoppage pump driving process. The stopped state process is executed both at the automatic stopping and the manual stopping of the engine 10.

When starting the stopped state process in response to stoppage of the engine 10, the ECM 40 obtains, in step S100, the current values of the housing temperature TH1, the seal ring temperature TH2, the bearing temperature TH3, and the oil drain temperature TH4. These temperatures indicate the temperature state of the turbocharger 20 when the engine 10 is stopped.

Subsequently, the ECM 40 calculates a first request driving time TM1, a second request driving time TM2, a third request driving time TM3, and a fourth request driving time TM4 in step S110. The first request driving time TM1 is calculated based on the housing temperature TH1, which has been obtained in step S100, using a first calculation map MAP1. The first request driving time TM1 represents driving time of the electric pump 31 required to lower the housing temperature TH1 to an appropriate temperature. The second request driving time TM2 is calculated based on the seal ring temperature TH2, which has been obtained in step S100, using a second calculation map MAP2. The second request driving time TM2 represents driving time of the electric pump 31 required to lower the seal ring temperature TH2 to an appropriate temperature that reduces the formation of oil coke. The third request driving time TM3 is calculated based on the bearing temperature TH3, which has been obtained in step S100, using a third calculation map MAP3. The third request driving time TM3 represents driving time of the electric pump 31 required to lower the bearing temperature TH3 to an appropriate temperature that reduces the formation of oil coke. The fourth request driving time TM4 is calculated based on the oil drain temperature TH4, which has been obtained in step S100, using a fourth calculation map MAP4. The fourth request driving time TM4 represents driving time of the electric pump 31 required to lower the oil drain temperature TH4 to an appropriate temperature that reduces the formation of oil coke. The first to fourth calculation maps MAP1 to MAP4 are each designed to set the value of the request driving time to 0 when the temperature of the corresponding site is lower than a certain value of the temperature. Also, the first to fourth calculation maps MAP1 to MAP4 are each designed to increase the value of the request driving time as the temperature of the site increases, when the temperature of the corresponding site is higher than or equal to the certain value of the temperature. The certain value is different for each of the first to fourth calculation maps MAP1 to MAP4. In the subsequent step S120, the ECM 40 sets the value of a request driving time TMR to the greatest value of the first to fourth request driving times TM1 to TM4.

Next, in step S130, the ECM 40 determines whether the request driving time TMR has been set to a value greater than 0. If the request driving time TMR has been set to 0 (NO), the cooling water does not need to be supplied to the turbocharger 20 after the engine 10 is stopped. In this case, the ECM 40 ends the stopped state process at the current stoppage of the engine 10. If the request driving time TMR has been set to a value greater than 0 (YES), the cooling water needs to be supplied to the turbocharger 20 after the engine 10 is stopped. In this case, the ECM 40 advances the process to step S140. In the present embodiment, step S130 corresponds to a determination process that determines whether the cooling water needs to be supplied to the turbocharger 20 after the engine 10 is stopped.

When advancing the process to step S140, the ECM 40 determines whether a recording completion flag is set in step S140. If the recording completion flag is set (YES), the ECM 40 advances the process to step S180. If the recording completion flag is not set (NO), the ECM 40 advances the process to step S150.

In step S150, the ECM 40 determines whether the current stoppage of the engine 10 has been caused by the automatic stopping. If the stoppage has been caused by the automatic stopping (YES), the ECM 40 advances the process to step S180. If the current stoppage has not been caused by the automatic stopping (NO), that is, if the current stoppage of the engine 10 has been caused by the manual stopping in response to an off operation of the ignition switch 43, the ECM 40 advances the process to step S160.

In step S160, the ECM 40 increments an execution counter, which is stored in the storage 42. In the present embodiment, the set range of the request driving time TMR is divided into multiple time sections, and an execution counter is prepared for each of the time sections. In step S160, the ECM 40 increments the execution counter for the time section that corresponds to the current set value of the request driving time TMR. The values of the execution counters in the storage 42 are retained even after power supply to the ECM 40 is stopped. In the subsequent step S170, the ECM 40 sets the recording completion flag and advances the process to step S180. In a case in which the recording completion flag is already set when the stopped state process is started as described above (S140: YES), and in a case of the automatic stopping (S150: YES), the ECM 40 advances the process to step S180 without incrementing the execution counter. In the present embodiment, step S160 corresponds to a recording process that records, in the storage 42, the number of times the post-stoppage pump driving process has been executed.

When advancing the process to step S180, the ECM 40 resets the value of a driving time counter TMC to 0 in step S180. After starting to drive the electric pump 31 in step S190, the ECM 40 ends the stopped state process at the current stoppage of the engine 10.

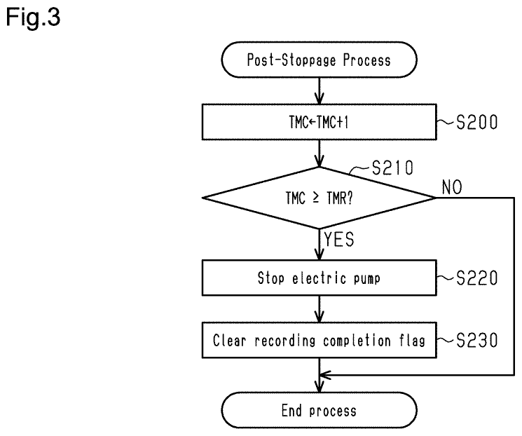

In a case in which the electric pump 31 is operating after the engine 10 is stopped, the ECM 40 executes a post-stoppage process shown in FIG. 3 at each predefined control cycle. When starting the post-stoppage process, the ECM 40 increments the driving time counter TMC in step S200. In step S210, the ECM 40 determines whether the value of the driving time counter TMC is greater than or equal to the value of the request driving time TMR. If the value of the driving time counter TMC is less than the value of the request driving time TMR (NO), the ECM 40 ends the post-stoppage process in the current control cycle. If the value of the driving time counter TMC is greater than or equal to the request driving time TMR (YES), the ECM 40 stops driving the electric pump 31 in step S220. After clearing the recording completion flag in step S230, the ECM 40 ends the post-stoppage process in the current control cycle.

In the present embodiment, the post-stoppage pump driving process is executed through the above-described stopped state process and the post-stoppage process. The post-stoppage pump driving process is completed when the electric pump 31 is driven for a time that corresponds to the value of the request driving time TMR. At the same time as the completion of the post-stoppage pump driving process, the recording completion flag is cleared.

If the engine 10 is restarted before the time corresponding to the value of the request driving time TMR elapses after the post-stoppage pump driving process is started, the post-stoppage pump driving process is suspended. In this case, the recording completion flag remains set.

If the temperature of the turbocharger 20 is relatively high after the engine 10 is restated, the ECM 40 drives the electric pump 31 to cool the turbocharger 20. The ECM 40 clears the recording completion flag when the turbocharger 20 is cooled so that the electric pump 31 is stopped.

<Operation and Advantages of Embodiment>

Operation and advantages of the present embodiment will now be described.

During high-load operation of the engine 10, high-temperature exhaust gas flows into the turbine housing 21, so that the temperature of the turbocharger 20 is relatively high. This can carbonize oil in the turbocharger 20, so that oil coke may be accumulated in the oil passage 29. During the operation of the engine 10, the electric pump 31 is driven to supply the cooling water to cool the turbocharger 20. In the present embodiment, in a case in which the engine 10 is stopped with the turbocharger 20 at a relatively high temperature, for example, immediately after a high-load operation, the post-stoppage pump driving process continues to drive the electric pump 31 even after the engine 10 is stopped. This cools the turbocharger 20 and thus reduces the formation and accumulation of oil coke.

When the engine 10 stopped, the alternator 15 stops generating power, so that the battery 14 stops being charged. Accordingly, if the post-stoppage pump driving process is executed to drive the electric pump 31 after the engine 10 is stopped, the amount of charge of the battery 14 decreases due to power consumption by the electric pump 31. If the operation of the electric pump 31 is performed frequently for an extended period of time by the post-stoppage pump driving process after the stoppage of the engine 10, the charging capability of the battery 14 is reduced. In other words, battery exhaustion may occur.

A vehicle may be brought to a car dealer when battery exhaustion occurs. In such a case, the car dealer identifies the cause of the battery exhaustion and performs necessary maintenance. Aside from the electric pump 31 having been driven after stoppage of the engine 10, a failure in the vehicle electrical system such as the alternator 15 may cause battery exhaustion.

In this regard, the number of times the post-stoppage pump driving process has been executed is stored in the storage 42 in the present embodiment. The number of times the post-stoppage pump driving process has been executed, which is stored in the storage 42, can be checked using a scanning tool at an auto repair shop such as a car dealer. This allows the cause of the battery exhaustion to be identified easily.

The engine controller of the present embodiment has the following advantages.

(1) The number of times the post-stoppage pump driving process has been executed is stored in the storage 42. This allows the cause of battery exhaustion to be identified easily.

(2) In the present embodiment, the driving time of the electric pump 31 in the post-stoppage pump driving process is varied depending on the temperature state of the turbocharger 20 at the stoppage of the engine 10. The operation of the electric pump 31 caused by the post-stoppage pump driving process affects the charging capability of the battery 14 more when the driving time is relatively long than when the driving time is relatively short. In the present embodiment, the number of times the post-stoppage pump driving process has been executed is recorded for each of the time sections of the driving time. It is thus easy to determine whether the cause of battery exhaustion is the operation of the electric pump 31 in the post-stoppage pump driving process.

(3) When the amount of charge of the battery 14 is relatively low, the automatic stopping of the engine 10 is not performed. Also, the battery 14 restarts to be charged by the restarting of the engine 10 after the automatic stopping. Thus, the post-stoppage pump driving process at the automatic stopping is unlikely to cause reduction in the charging capability of the battery 14. In this regard, the execution of the post-stoppage pump driving process at the automatic stopping is not included in the number of times of execution in the present embodiment. It is thus easy to reliably determine whether the cause of battery exhaustion is the operation of the electric pump 31 in the post-stoppage pump driving process.

(4) If stopping and restarting of the engine 10 are repeated, the post-stoppage pump driving process may be executed each time the engine 10 is stopped. In such a case, the operation of the electric pump 31 in the post-stoppage pump driving process is discontinued after a short period of time. The charging capability of the battery 14 is thus not easily reduced. If the number of times the post-stoppage pump driving process has been executed is recorded faithfully, it may be difficult to identify the cause of battery exhaustion from the number of times of the execution. In this regard, in the present embodiment, when the post-stoppage pump driving process is executed repeatedly due to repeated stopping and restarting of the engine 10, the number of times the post-stoppage pump driving process has been executed is recorded as one time. It is thus easy to reliably determine whether the cause of battery exhaustion is the operation of the electric pump 31 in the post-stoppage pump driving process.

The above-described embodiment may be modified as follows. The above-described embodiment and the following modifications can be combined as long as the combined modifications remain technically consistent with each other.

The recorded number of times the post-stoppage pump driving process has been executed may include the number of times the process has been executed at the automatic stopping of the engine 10 and the number of times the process has been executed when stopping and restarting of the engine 10 are repeated.

In the above-described embodiment, the number of times the post-stoppage pump driving process has been executed is recorded for each of the time sections of the driving time. This allows the driving time of the electric pump 31 in the process to be determined with a certain level of accuracy. Information of the driving time of the electric pump 31 can be recorded by a method other than recording the number of times the post-stoppage pump driving process has been executed for each of the time sections of the driving time of the electric pump 31. For example, a method may be employed that records the total driving time or an average driving time of the electric pump 31 in the post-stoppage pump driving process. In any case, if information of the driving time of the electric pump 31 in the post-stoppage pump driving process is recorded together with the number of times the process has been executed, such information is useful to identify the cause of battery exhaustion.

For example, in a case in which the driving time of the electric pump 31 in the post-stoppage pump driving process is fixed, only the number of times of the process has been executed may be recorded.

The ECM 40 or the processing device 41 may include one or more processors that perform various processes according to computer programs (software). The ECM 40 or the processing device 41 may be circuitry including one or more dedicated hardware circuits such as application specific integrated circuits (ASICs) that execute at least part of various processes, or a combination thereof. The processor includes a CPU and a memory such as a RAM and a ROM. The memory stores program code or instructions configured to cause the CPU to execute processes. The memory, which is a computer-readable medium, includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An engine controller configured to control an engine, the engine being mounted on a vehicle and including a turbocharger and an electric pump that supplies a cooling water to the turbocharger, the engine controller comprising:
a processor; and
a storage, wherein
the processor is configured to execute:
a determination process that determines whether the cooling water needs to be supplied to the turbocharger after the engine is stopped;
a post-stoppage pump driving process that drives the electric pump after the engine is stopped if the determination process determines that the cooling water needs to be supplied; and
a recording process that records, in the storage, a number of times of execution of the post-stoppage pump driving process.

2. The engine controller according to claim 1, wherein
the post-stoppage pump driving process includes varying of driving time of the electric pump after stoppage of the engine depending on a temperature state of the turbocharger at the stoppage of the engine, and
the recording process includes recording of information of the driving time together with the number of times of execution.

3. The engine controller according to claim 2, wherein the processor is configured to
divide a set range of the driving time into time sections, and
record the number of times of execution of the post-stoppage pump driving process for each of the time sections.

4. The engine controller according to claim 1, wherein
the vehicle performs automatic stopping and automatic restarting of the engine in accordance with a traveling condition of the vehicle, and
the recording process does not record the number of times of execution of the post-stoppage pump driving process if the post-stoppage pump driving process is executed in response to the automatic stopping.

5. The engine controller according to claim 1, wherein, if the post-stoppage pump driving process is executed repeatedly due to repeated stopping and restarting of the engine, the recording process records, as one time, the number of times of execution of the post-stoppage pump driving process.

6. An engine controlling method configured to control an engine, the engine being mounted on a vehicle and including a turbocharger and an electric pump that supplies a cooling water to the turbocharger, the engine controlling method comprising:
determining whether the cooling water needs to be supplied to the turbocharger after the engine is stopped;
executing a post-stoppage pump driving process that drives the electric pump after the engine is stopped if it is determined that the cooling water needs to be supplied; and
recording, in a storage, a number of times of execution of the post-stoppage pump driving process.
